(19) United States
(12) Patent Application Publication
(10) Pub. No.: US 2005/0273806 A1
(43) Pub. Date: Dec. 8, 2005

(54) Remote control system for a multimedia scene

(76) Inventor: Laurent Herrmann, Le Kremlin Bicetre (FR)

Correspondence Address: PHILIPS INTELLECTUAL PROPERTY & STANDARDS, P.O. BOX 3001, BRIARCLIFF MANOR, NY, 10510, US

(21) Appl. No.: 10/515,694

(22) PCT Filed: May 19, 2003
(86) PCT No.: PCT/IB03/02137

§ 371 Date: Nov. 24, 2004

(30) Foreign Application Priority Data
May 28, 2002 (FR) 0206502

(51) Int. Cl. H04N 7/025; G06F 3/00; H04N 5/445

(52) U.S. Cl. 725/32; 725/37; 725/135

(57) ABSTRACT

The invention relates to a control system for a multimedia scene defined by a scene description, said control system comprising a video receiver suitable for receiving the multimedia scene, and a remote control device provided with keys. The video receiver is intended to communicate with the remote control device. To this end, it comprises a user interface intended to identify a key of the remote control device when it is pressed and to associate said key with a key of a virtual keyboard defined in the scene description. It also comprises means intended to activate the key of the virtual keyboard and to execute a command associated with said key, said command being intended to modify a content of the multimedia scene.

The invention relates to a control system for a multimedia scene defined by a scene description, the control system comprising a video receiver suitable for receiving the multimedia scene.

It also relates to a method of controlling a multimedia scene defined by a scene description.

The invention notably finds its application in apparatuses which are compatible with the MPEG4 standard or an equivalent standard by which a user can interact with the content of a multimedia scene.

The MPEG4 standard comprises tools allowing the composition of a set of multimedia objects such as, for example, a person, a background, a piece of furniture or a voice, within a multimedia scene. The information required for the composition of the scene forms a scene description which is encoded and transmitted with the multimedia objects. The MPEG-4 standard has developed a binary language for the scene description, referred to as BIFS format (Binary Format for Scene). In a general manner, the scene descriptions are encoded independently of the different multimedia objects. These scene descriptions notably comprise the parameters allowing modification of a multimedia object, for example, its position in the scene.

An MPEG4 scene has a hierarchic structure which may be represented in the form of a tree. Each node of this tree is a multimedia object. The tree structure is not necessarily static; node attributes such as parameters for positioning the multimedia object may be modified, while nodes may be added, replaced or removed in said tree structure.

In accordance with the MPEG-4 standard, the multimedia objects have a temporal and spatial dimension. Each multimedia object has its own local system of coordinates. This local system of coordinates allows manipulation of the multimedia objects both in space and in time. The multimedia objects are positioned in a scene by virtue of a geometrical transformation which is suitable for converting the coordinates of the multimedia object in the local system of coordinates into coordinates in a global system of coordinates defined by a parent node of the scene description in the tree.

The multimedia objects and the scene description n( [symbol] parameters for a composition layer through which their behavior such as, for example, the intensity of a sound or the color of a video object can be controlled.

In order that a user can interact with the content of the multimedia scene, the standards VRML97: ISO/IEC 14772-1: 1997 and MPEG-4 systems: ISO/IEC 14496-1 have created a specific node referred to as TouchSensor node. This node provides the possibility of following the position and the state of a cursor device of the computer mouse type and of detecting when the user clicks with said cursor device in a zone comprising the TouchSensor node corresponding to a multimedia object selected in the scene.

However, the interactivity with an MPEG-4 scene is currently only possible with such a cursor device.

It is an object of the present invention to propose a system and a method of controlling a multimedia scene defined by a scene description allowing interaction with a multimedia scene by means of a remote control device, i.e. without the use of a cursor device.

To this end, the video receiver included in the control system according to the invention is characterized in that it comprises a user interface intended to identify a key of the remote control device when it is pressed and to associate said key with a key of a virtual keyboard defined in the scene description, and means intended to activate the key of the virtual keyboard and to execute a command associated with said key, said command being intended to modify a content of the multimedia scene.

The present invention is thus adapted to interface a remote control device with a multimedia scene by virtue of the creation of a virtual keyboard in the scene description. With this virtual keyboard and an adapted user interface, a user can interact with the multimedia scene by means of a remote control device in a manner which is similar to that previously realized by means of a cursor device.

These and other aspects of the invention are apparent from and will be elucidated, by way of non-limitative example, with reference to the embodiment(s) described hereinafter.

In the drawings:

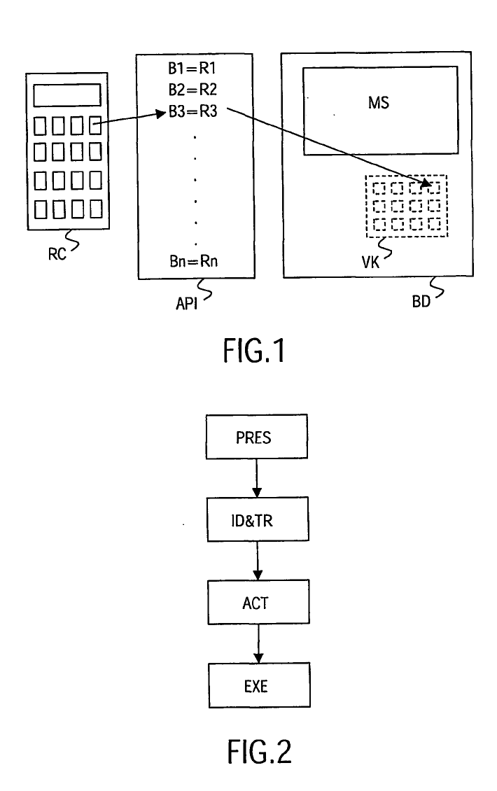

FIG. 1 illustrates the operation of a video receiver ac [symbol] when it communicates with a remote control device; and

FIG. 2 is a block diagram illustrating the method of assigning a behavior to a key of the remote control device.

The present invention relates to the control of multimedia scenes by means of a remote control device. In the preferred embodiment, the multimedia scenes are the result of an encoding/decoding operation in accordance with the MPEG4 standard, but they may alternatively be the result of an encoding/decoding operation in accordance with a standard which is equivalent to the MPEG-4 standard.

FIG. 1 illustrates the operation of a video receiver according to the invention, said receiver being suitable for receiving a scene defined by a scene description. The video receiver is, for example, a set top box for digital television. It is intended to communicate with a remote control device RC provided with keys Bi, i being an integer between 1 and n, n being the number of keys of the device RC. The remote control device is, for example, an infrared remote control unit which is capable of emitting specific codes.

The video receiver comprises a user interface API intended to associate a key Bi of the remote control device with a key Ri of a virtual keyboard VK defined in the scene description BD. To this end, transparent rectangles are created in the BIFS scene description, which rectangles are positioned outside a screen where the multimedia scene MS will be displayed, or in a zone of the screen with which the user cannot interact. These transparent rectangles correspond to the keys Ri of the virtual keyboard, which constitutes a representation of the remote control device in a virtual space. The user interface API comprises, for example, a memory intended to store a matrix of the positions of the keys of the virtual keyboard.

Moreover, each key of the virtual keyboard is associated with a specific node of the BIFS scene description, which is a TouchSensor node. When a key of the remote control device is pressed, the user interface is suitable to convert the pressure on said key into a position of a key of the virtual keyboard and to subsequently activate the key of the virtual keyboard in the BIFS scene description. A particular behavior can be assigned to the key of the virtual keyboard in order to execute a command intended to modify a content of the scene. This assignment of a behavior is realized by using a mechanism for managing BIFS events which are known to those skilled in the art. Thanks to the invention, it is thus possible to navigate between the different video sequences within a mosaic i [symbol] by means of a remote control unit.

FIG. 2 describes the method of assigning a behavior to a key of the remote control device. This method comprises the steps of:
pressing PRES on a key of the remote control device;
identifying ID&TR the key of the remote control device thus pressed and converting said key into a key of the virtual keyboard via the user interface;
activating ACT the key of the virtual keyboard by way of the TouchSensor node of the tree describing the BIFS scene; and
executing EXE a command associated with the key of the virtual keyboard by the BIFS event manager.

The BIFS scene must carry out the complete description of the keys of the virtual keyboard. An example of a part of a BIFS scene describing a key of the virtual keyboard is given below in the VRML language, with comments preceded by the sign #.

# Definition of a key ARROW_UP of a virtual keyboard #

Transform 2D
{

| | |
|---|---|
| translation −50 100 | # position of the key in the scene |
| children | |
| { | |

| DEF ARROW_UP TouchSensor { } # this key may be | |
|---|---|
| activated | |
| Shape | # definition of the geometry of the key |
| { | |

| | |
|---|---|
| geometry Rectangle {size 2 2} | # a square of 2 × 2 pixels |
| appearance Appearance | |
| { | |

material Material2D
{

| emissiveColor 0 0 0 | |
|---|---|
| filled FALSE | |
| transparency 1 | # key not visible |
| } | |
| 5 | |

}

}

}

}

. . .

# Event management
ROUTE ARROW_UP.isActive to NODE.activate # if the key ARROW_UP is activated, a command is executed ...

An example of an implementation in the language C of the user interface API corresponding to the key ARROW_UP of the virtual keyboard is the following, with comments preceded by the sign //.

UserKeyPressed(Byte code)
{

| struct {int x; Int y; } KEY_LOC; // position variables of the keys of | |
|---|---|
| the virtual keyboard | |
| switch ( code) | // selection in accordance with the pressed key of |

the remote control unit
{
// list of codes of the keys of the remote control unit
. . .
case UP_KEY_CODE: {KEY_LOC.x=−50; KEY_LOC.y=100;
break; }
. . .
}
Double this_time = get_current_media time( );
MouseAt(KEY_LOC.x, KEY_LOC.y, MOUSE_LEFT_{—}
BUTTON_DOWN, this time);
// function allowing, when a key of the remote control unit is pressed,
execution of a command as if a mouse click had taken place at the
position (x,y).

}

It should be noted that any reference sign between parentheses in the present text should not be construed as limiting the claims. Use of the verb “comprise” and its conjugations does not exclude the presence of elements or steps otl [symbol] claims. Use of the article “a” or “an” preceding an element or step does not exclude the presence of a plurality of such elements or steps.

1. A control system for a multimedia scene defined by a scene description, the control system comprising a video receiver suitable for receiving the multimedia scene, and a remote control device provided with keys, the video receiver being intended to communicate with the remote control device and comprising:
a user interface intended to identify a key of the remote control device when it is pressed and to associate said key with a key of a virtual keyboard defined in the scene description;
means intended to activate the key of the virtual keyboard and to execute a command associated with said key, said command being intended to modify a content of the multimedia scene.

2. A video receiver suitable for receiving a multimedia scene defined by a scene description, said video receiver being intended to communicate with a remote control device provided with keys and comprising:
a user interface intended to identify a key of the remote control device when it is pressed and to associate said key with a key of a virtual keyboard defined in the scene description;
means intended to activate the key of the virtual keyboard and to execute a command associated with said key, said command being intended to modify a content of the multimedia scene.

3. A control method, by means of a remote control device provided with keys, for a multimedia scene defined by a scene description, the scene description comprising a virtual keyboard whose keys correspond to keys of the remote control device, said method comprising the steps of:
identifying a key of the remote control device when it is pressed;
converting said key into a key of the virtual keyboard;
activating the key of the virtual keyboard; and
executing a command associated with the key of the virtual keyboard.
